(19) United States
(12) Patent Application Publication
(10) Pub. No.: US 2018/0204404 A1
(43) Pub. Date: Jul. 19, 2018

(54) PAPER SHEET PROCESSING DEVICE

(71) Applicants: LAUREL BANK MACHINES CO., LTD., Tokyo (JP); LAUREL PRECISION MACHINES CO., LTD., Osaka-shi, Osaka (JP)

(72) Inventors: Tsuyoshi KOKUBO, Tokyo (JP); Masahiro HAGIHARA, Kasukabe-shi (JP); Yasuhiro ONODERA, Tsukuba-shi (JP); Kiyotaka TOMURA, Kawaguchi-shi (JP); Motonori SHINAGAWA, Saitama-shi (JP)

(21) Appl. No.: 15/741,849

(22) PCT Filed: Jul. 12, 2016
(86) PCT No.: PCT/JP2016/070561

§ 371 Date: Jan. 4, 2018

(30) Foreign Application Priority Data
Jul. 17, 2015 (JP) 2015-142881

(51) Int. Cl. G07D 11/00; B65H 43/00; B65H 5/06

(52) U.S. Cl. CPC G07D 11/0033; G07D 11/0084; G07D 11/0009; G07D 7/00; G07D 11/0018; B65H 43/00; B65H 5/062; G07D 11/0012

(57) ABSTRACT

A paper sheet processing device includes: an identification unit that identifies a paper sheet; a temporary holding unit that temporarily holds the identified paper sheet; and a linear transport path that connects the identification unit and the temporary holding unit, extends in a straight line, and transports the paper sheet identified by the identification unit to the temporary holding unit.

### TECHNICAL FIELD

The present invention relates to a paper processing device.

Priority is claimed on Japanese Patent Application No. 2015-142881, filed Jul. 17, 2015, the content of which is incorporated herein by reference.

### BACKGROUND ART

There is conventionally known a bill processing device that temporarily holds in a temporary holding unit bills deposited from a money deposit unit and identified by an identification unit and, after the completion of various processes, transports the bills from the temporary holding unit to a storage unit to be stored (for example, refer to Patent Document 1).

### PRIOR ART DOCUMENTS

### Non-Patent Document

[Patent Document 1] Japanese Patent No. 5485388

### SUMMARY OF INVENTION

### Problem to be Solved by the Invention

However, in a conventional bill processing device such as that in Patent Document 1, for example, the money deposit unit is arranged at the front of the device, the temporary holding unit is arranged under this money deposit unit, and the identification unit is arranged at the rear of the device. Moreover, the money deposit unit, the identification unit, and the temporary holding unit are connected via an annular transport path having a plurality of curved portions.

In the conventional bill processing device, since the identification unit is arranged at the rear of the device, the temporary holding unit is arranged at the front of the device, and the identification unit and the temporary holding unit are connected via the annular transport path, bills that have been identified by the identification unit, by being transported to the front of the device after having been once transported to the rear of the device via the annular transport unit, are transported in a curved manner to the temporary holding unit via a U-shaped detour. For this reason, since the transport distance from the identification unit to the temporary holding unit is long and the bills pass through multiple curves and branches in the transport path, there is a high possibility of a jam occurring.

Accordingly, an object of the present invention is to provide a paper sheet processing device that can inhibit the occurrence of jamming.

### Means for Solving the Problem

In order to attain the aforementioned object, a paper sheet processing device according to an aspect of the present invention includes: an identification unit that identifies a paper sheet; a temporary holding unit that temporarily holds the identified paper sheet; and a linear transport path that connects the identification unit and the temporary holding unit, extends in a straight line, and transports the paper sheet identified by the identification unit to the temporary holding unit.

### Effect of the Invention

According to the present invention, the identification unit and the temporary holding unit are connected by the linear transport path that extends in a straight line, and a paper sheet that is identified by the identification unit is transported to the temporary holding unit by the linear transport path. For this reason, the paper sheet is not transported in a curved manner from the identification unit to the temporary holding unit. Accordingly, it is possible to inhibit the occurrence of jamming.

### BRIEF DESCRIPTION OF THE DRAWINGS

FIG. 1 is a side view that schematically shows a paper sheet processing device according to a first embodiment of the present invention.

FIG. 2 is a plan view that schematically shows a lower unit of the paper sheet processing device according to the first embodiment of the present invention.

FIG. 3A is a side view that schematically shows the paper sheet processing device according to the first embodiment of the present invention, with a deposit process route indicated with heavy lines.

FIG. 3B is a side view that schematically shows the paper sheet processing device according to the first embodiment of the present invention, with a storage process route indicated with heavy lines.

FIG. 4 is a side view that schematically shows the paper sheet processing device according to the first embodiment of the present invention, with a return process route indicated with heavy lines.

FIG. 5A is a side view that schematically shows the paper sheet processing device according to the first embodiment of the present invention, with a front stage route of an arrangement and counting process route indicated with heavy lines.

FIG. 5B is a side view that schematically shows the paper sheet processing device according to the first embodiment of the present invention, with a rear stage route of the arrangement and counting process route indicated with heavy lines.

FIG. 6 is a side view that schematically shows the paper sheet processing device according to the first embodiment of the present invention, with a dispensing process route indicated with heavy lines.

FIG. 7A is a side view that schematically shows the paper sheet processing device according to the first embodiment of the present invention, with a front stage route of a dispensing evacuation process route indicated with heavy lines.

FIG. 7B is a side view that schematically shows the paper sheet processing device according to the first embodiment of the present invention, with a rear stage route of the dispensing evacuation process route indicated with heavy lines.

FIG. 8A is a side view that schematically shows the paper sheet processing device according to the first embodiment of the present invention, with an outbound route of a scrutinization process indicated with heavy lines.

FIG. 8B is a side view that schematically shows the paper sheet processing device according to the first embodiment of the present invention, with a return route of the scrutinization process indicated with heavy lines.

FIG. 9A is a side view that schematically shows the paper sheet processing device according to the first embodiment of the present invention, with a front stage route of a cassette replenishment process indicated with heavy lines.

FIG. 9B is a side view that schematically shows the paper sheet processing device according to the first embodiment of the present invention, with a rear stage route of the cassette replenishment process indicated with heavy lines.

FIG. 10A is a side view that schematically shows the paper sheet processing device according to the first embodiment of the present invention, with a front stage route of a deposit port replenishment process indicated with heavy lines.

FIG. 10B is a side view that schematically shows the paper sheet processing device according to the first embodiment of the present invention, with a rear stage route of the deposit port replenishment process indicated with heavy lines.

FIG. 11A is a side view that schematically shows the paper sheet processing device according to the first embodiment of the present invention, with a front stage route of a collection process indicated with heavy lines.

FIG. 11B is a side view that schematically shows the paper sheet processing device according to the first embodiment of the present invention, with a rear stage route of the collection process indicated with heavy lines.

FIG. 12 is a side view that schematically shows a paper sheet processing device according to a second embodiment of the present invention.

FIG. 13 is a side view that schematically shows the paper sheet processing device according to the second embodiment of the present invention, with a deposit process route indicated with heavy lines.

FIG. 14A is a side view that schematically shows the paper sheet processing device according to the second embodiment of the present invention, with a front stage route of an outbound process of a scrutinization process indicated with heavy lines.

FIG. 14B is a side view that schematically shows the paper sheet processing device according to the second embodiment of the present invention, with a rear stage route of the outbound process of the scrutinization process indicated with heavy lines.

FIG. 15A is a side view that schematically shows the paper sheet processing device according to the second embodiment of the present invention, with a front stage route of a return process of the scrutinization process indicated with heavy lines.

FIG. 15B is a side view that schematically shows the paper sheet processing device according to the second embodiment of the present invention, with a rear stage route of the return process of the scrutinization process indicated with heavy lines.

FIG. 16A is a side view that schematically shows the paper sheet processing device according to the second embodiment of the present invention, with a front stage route of a collection process indicated with heavy lines.

FIG. 16B is a side view that schematically shows the paper sheet processing device according to the second embodiment of the present invention, with a rear stage route of the collection process indicated with heavy lines.

### EMBODIMENTS FOR CARRYING OUT THE INVENTION

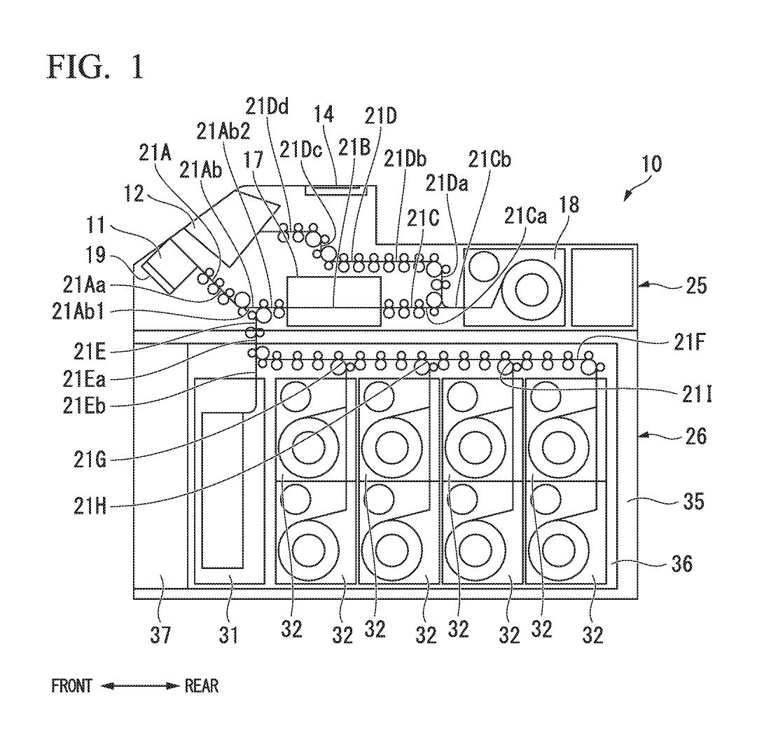

A paper sheet processing device according to a first embodiment of the present invention will be described below referring to FIG. 1 to FIG. 11B. A paper sheet processing device 10 according to the first embodiment processes bills as paper sheets. The paper sheet processing device 10 may also process paper sheets other than bills. The paper sheet processing device 10 is a bill depositing and dispensing device that is capable of a deposit process that internally stores bills input from outside, and a dispensing process that dispenses internally stored bills so as to be removable to the outside. In the following description, “front” denotes the operator side, “rear” denotes the side opposite the operator, “left” denotes the left viewed from the operator, and “right” denotes the right viewed from the operator.

As shown in FIG. 1, the paper sheet processing device 10 includes an input unit 11 that is provided in the upper portion of the front surface side and into which bills for deposit are input from outside. The paper sheet processing device 10 includes a payout unit 12 provided above and to the rear of this input unit 11. Reject bills that cannot be accepted among bills for deposit are fed out from the inside to the payout unit 12, and bills for dispensing are fed out from the inside to the payout unit 12. The payout unit 12 makes these bills be capable of being removed to the outside.

The input unit 11 and the payout unit 12 are provided at positions overlapped (agreeing) in the height direction (the vertical direction, height direction of the paper sheet processing device 10), and are provided at positions overlapped (agreeing) in the front-rear direction. The paper sheet processing device 10 includes an operation display unit 14 that is provided on the upper surface to the rear of the payout unit 12. The operation display unit 14 is a touch panel type and receives operation inputs of the operator and performs display to the operator.

The paper sheet processing device 10 includes an identification unit 17 provided to the rear of the input unit 11. The identification unit 17 identifies a bill, and is provided at a position overlapped (agreeing) with the input unit 11 in the height direction. The paper sheet processing device 10 includes a temporary holding unit 18 provided to the rear of this identification unit 17. The temporary holding unit 18 temporarily holds the bill identified by the identification unit 17, and is provided at a position overlapped (agreeing) with the input unit 11 and identification unit 17 in the height direction. The positions of the lower portion of the input unit 11 and the upper portion of the identification unit 17 are overlapped (agreeing) in the height direction. The positions of the upper portion of the input unit 11 and the lower portion of the identification unit 17 are shifted in the height direction. The positions of the entirety of the identification unit 17 and the middle portion to lower portion of the temporary holding unit 18 are overlapped (agreeing) in the height direction. The position of the upper portion of the temporary holding unit 18 is shifted in the height direction with respect to the identification unit 17.

The positions of the upper portion of the temporary holding unit 18 and the lower portion of the payout unit 12 are overlapped (agreeing) in the height direction.

The input unit 11, the identification unit 17, and the temporary holding unit 18 are arranged in the order of the input unit 11, the identification unit 17, and the temporary holding unit 18 from the front to the rear of the paper processing device 10. The positions of the input unit 11 and the identification unit 17 are completely shifted in the front-rear direction. The positions of the identification unit 17 and the temporary holding unit 18 are completely shifted in the front-rear direction (the horizontal direction, the front-rear direction of the paper processing device 10, the direction perpendicular to the height direction of the paper processing device 10).

A placing plate 19 is provided in a rear-downward orientation in the input unit 11. This placing plate 19 performs the operations of ascending in the rear-upward direction and descending in the front-downward direction within the input unit 11. Bills in a collected state are placed from outside on the placing plate 19 in the state following the descending operation. As a result, the bills placed on the placing plate 19 enter a state of being collected in the rear-upward direction. The placing plate 19, by ascending, transports the collected-state bills in a rear-up orientation, and feeds the collected-state bills one at a time from the top-end bill in the collection direction into the paper sheet processing device 10.

A deposit transport path 21A that transports bills fed from the input unit 11 is connected to the rear end portion of the input unit 11. The deposit transport path 21A has an inclined sending portion 21Aa that extends downward toward the rear from the input unit 11, and a horizontal sending path portion 21Ab that extends horizontally toward the rear from the rear end of the inclined sending portion 21Aa. The deposit transport path 21A is connected to the identification unit 17 at the rear end portion of the horizontal sending path portion 21Ab.

The identification unit 17 has an internal transport path 21B that is arranged on the same straight line as the horizontal sending path portion 21Ab of the deposit transport path 21A and that extends horizontally rearward from the rear end portion of the horizontal sending path portion 21Ab. The internal transport path 21B continuously transports bills rearward from the horizontal sending path portion 21Ab. The identification unit 17 identifies the authenticity, damage, denomination, overlap, skew and the like of bills being transported by the internal transport path 21B.

A linear transport path 21C extends from the rear end portion of the internal transport path 21B of the identification unit 17 horizontally rearward. The rear end portion of this linear transport path 21C is connected to the temporary holding unit 18. The linear transport path 21C continuously conveys bills rearward from the internal transport path 21B. The horizontal sending path portion 21Ab of the deposit transport path 21A, the internal transport path 21B, and the linear transport path 21C are linearly aligned on the same straight line. The identification unit 17 and the temporary holding unit 18 are connected by the straight linear transport path 21C. That is, the linear transport path connects the identification unit 17 and the temporary holding unit 18, and extends in a straight line. In other words, the linear transport path 21C has a distal end portion (first end) that connects with the identification unit 17 and a rear end portion (second end) connected to the temporary holding unit 18, and extends horizontally in a straight line from the rear end portion to the distal end portion. For example, a bill input to the input unit 11 is transported from the input unit 11 towards the identification unit 17 by the deposit transport path 21A, and after identification by the identification unit 17 is transported by the linear transport path 21C to the temporary holding unit 18. That is, the linear transport path 21C transports the bill horizontally from identification unit 17 to temporary holding unit 18, maintaining the position of the bill identified by the identification unit 17 in the vertical direction. In other words, the linear transport path 21C transports the bill from the identification unit 17 to the temporary holding unit 18 with the bill identified by the identification unit 17 maintained in a non-curved state. As mentioned above, the positions of the identification unit 17 and the temporary holding unit 18 are overlapped (agreeing) in the height direction. That is, the position of the identification unit 17 in the vertical direction and the position of the temporary holding unit 18 in the vertical direction are matched. The linear transport path 21C extends in the transverse direction, specifically, the horizontal direction, connecting the identification unit 17 and the temporary holding unit 18.

The temporary holding unit 18 temporarily holds bills, takes in and stores the bills transported by the linear transport path 21C one by one, and feeds the stored bills one by one to the linear transport path 21C. This temporary holding unit 18 is a winding-storing type that winds the bills together with tape on a drum for storage and uncoils the bills together with the tape from the drum for feeding.

From the middle position (intermediate position) of the linear transport path 21C, a dispensing transport path 21D branches upward. This dispensing transport path 21D is connected to the payout unit 12. By the branching of the dispensing transport path 21D, the linear transport path 21C is divided into a front side sending path portion 21Ca on the front side of the branch position of the dispensing transport path 21D and a rear side sending path portion 21Cb on the rear side of the branch position of the dispensing transport path 21D. Coming and going of bills between the front side sending path portion 21Ca and the rear side sending path portion 21Cb are possible. Between the front side sending path portion 21Ca and the dispensing transport path 21D, transport of bills from the front side sending path portion 21Ca to the dispensing transport path 21D is possible. Between the rear side sending path portion 21Cb and the dispensing transport path 21D, transport of bills from the rear side sending path portion 21Cb to the dispensing transport path 21D is possible.

The dispensing transport path 21D transports bills transported by the linear transport path 21C to the payout unit 12. The dispensing transport path 21D has a vertical sending path portion 21Da, a horizontal sending path portion 21Db, a vertical sending path portion 21Dc, and a horizontal sending path portion 21Dd. The vertical sending path portion 21Da extends vertically upward from the middle position (intermediate position) of the linear transport path 21C. The horizontal sending path portion 21Db extends horizontally frontward from the upper end portion of the vertical sending path portion 21Da. The vertical sending path portion 21Dc extends vertically upward from the front end portion of the horizontal sending path portion 21Db. The horizontal sending path portion 21Dd extends horizontally frontward from the upper end portion of the vertical sending path portion 21Dc, to be connected to the payout unit 12.

The payout unit 12 collects bills fed out from the horizontal sending path portion 21Dd of the dispensing transport path 21D in a manner inclined from the front side and lower side to the rear side and upper side. The bills collected in the payout unit 12 are removed to the outside from the payout unit 12. The dispensing transport path 21D is a transport path that branches upward from the middle of the linear transport path 21C. Therefore, the dispensing transport path 21D for example transports bills fed out from the temporary holding unit 18 to the linear transport path 21C upward from the middle of the linear transport path 21C, and emits them to the payout unit 12.

An upper unit 25 constitutes the upper portion of the paper sheet processing device 10. The upper unit 25 includes the input unit 11, the payout unit 12, the operation display unit 14, the identification unit 17 including the internal transport path 21B, the temporary holding unit 18, the deposit transport path 21A, the linear transport path 21C, and the dispensing transport path 21D.

A lower unit 26 is provided on the lower side of the upper unit 25, and constitutes the lower portion to the middle portion of the paper sheet processing device 10 in the height direction. The lower unit 26 includes a front cassette 31 provided in the front portion position and storage containers 32 provided to the rear of the front cassette 31. There are a total of eight storage containers 32. The storage containers 32 are arranged in two stages in the vertical direction and in four rows in the front-rear direction. Of the eight storage containers 32, the positions of the four at the upper stage are made to agree in the height direction. Of the storage containers 32, the positions of the four at the lower stage are made to agree in the height direction. The height of the front cassette 31 is equivalent to the height of two of the storage containers 32. The front cassette 31 is overlapped (agreeing) with the position in the height direction of the storage containers 32 of two stages arranged vertically.

From the middle position (intermediate position) of the horizontal sending path portion 21Ab of the deposit transport path 21A, a vertical transport path 21E branches downward. This vertical transport path 21E extends vertically downward from the horizontal sending path portion 21Ab to be connected to the front cassette 31. By the branching of the vertical transport path 21E, the horizontal sending path portion 21Ab of the deposit transport path 21A is divided into a front-side constituent portion 21Ab1 to the front of the branch position of the vertical transport path 21E, and a rear-side constituent portion 21Ab2 to the rear of the branch position of the vertical transport path 21E. Transport of bills from the front-side constituent portion 21Ab1 to the rear-side constituent portion 21Ab2 is possible between the front-side constituent portion 21Ab1 and the rear-side constituent portion 21Ab2. The coming and going of bills is possible between the vertical transport path 21E and the rear-side constituent portion 21Ab2. The vertical transport path 21E is a transport path that branches downward from the middle of the deposit transport path 21A on the opposite side of the linear transport path 21C of the identification unit 17. Thereby, the vertical transport path 21E for example transports bills fed from the temporary holding unit 18 to the linear transport path 21C and passed through the identification unit 17 downward from the middle of the deposit transport path 21A and stores the bills in the front cassette 31.

The front cassette 31 can store bills by taking in bills one at a time, and can feed out bills that are stored one at a time. The front cassette 31 is a stacking-storing type that receives bills from the upper portion, collects and stores the bills in a horizontal state from bottom to top, and feeds out the stored bills from the top end bill. The stacking-storing type front cassette 31 has a substantially higher bill storing efficiency compared with a winding-storing type such as the temporary holding unit 18 and the storage container 32.

The storage transport path 21F branches rearward from the middle position (intermediate position) of the vertical transport path 21E. This storage transport path 21F, after extending horizontally rearward from the vertical transport path 21E, extends downward in the vicinity of the rear end portion of the paper sheet processing device 10 to be connected to the upper-stage storage container 32 at the rear end. Moreover, this storage transport path 21F is also connected to the lower-stage storage container 32 at the rear end via the upper-stage storage container 32 at the rear end. By the branching of the storage transport path 21F, the vertical transport path 21E is divided into an upper side sending path portion 21Ea to the upper side of the branch position of the storage transport path 21F, and a lower side sending path portion 21Eb to the lower side of the branch position of the storage transport path 21F.

From the middle position (intermediate position) of the storage transport path 21F, a plurality, specifically three, branch transport paths 21G, 21H, 21I branch off downward. The branch transport paths 21G, 21H, 21I are respectively connected to the upper-stage storage containers 32 of the front three rows. Moreover, the branch transport paths 21G, 21H, 21I are respectively, via the upper-stage storage containers 32 to which they are respectively connected to, connected to the lower-stage storage containers 32 arranged in the same rows as the upper-stage storage containers 32 that they are respectively connected to.

The eight storage containers 32 are all of the winding-storing type that stores bills by winding them with tape on a drum and feeds the bills out by uncoiling the bills together with the tape from the drum, and perform the feeding out while counting the bills. The winding-storing type storage container 32 stores bills in the order received, and feeds out bills in the opposite order of the storage order. For this reason, even in the case of storing bills of a plurality of denominations that are randomly mixed, it is possible to ascertain the denomination of each bill stored by the storage container 32 from the identification result of the identification unit 17. Thereby, it is possible to ascertain the denomination of each bill fed out from the storage container 32.

The storage transport path 21F and the branch transport paths 21G, 21H, 21I are transport paths that branch off to the rear from the middle of the vertical transport path 21E. Thereby, for example, after the bills are fed out from the temporary holding unit 18 to the linear transport path 21C and pass through the identification unit 17, the storage transport path 21F and the branch transport paths 21G, 21H, 21I transport the bills rearward from the middle of the vertical transport path 21E and selectively store in the eight storage containers 32 bills. For example, it is possible to set all of the eight storage containers 32 as single-denomination storage containers that store only bills of one denomination that has been respectively set. It is also possible to set some of the eight storage containers 32 as single-denomination storage containers that store only bills of one denomination that has been respectively set, and set the remainder as mixed-denomination storage containers that each store bills of a plurality of denominations in a mixture of denominations.

The lower unit 26 has the front cassette 31, the eight storage containers 32, the lower portion of the upper side sending path portion 21Ea of the vertical transport path 21E, the lower side sending path portion 21Eb, the storage transport path 21F, and the branch transport paths 21G to 21I. The upper unit 25 has the upper portion of the upper side sending path portion 21Ea of the vertical transport path 21E.

The lower unit 26 has a cabinet 35, a unit body 36, and a lid 37. The cabinet 35 opens to the front and has a rectangular parallelepiped box shape. The unit body 36 has the eight storage containers 32 and is arranged in the cabinet 35. The lid 37 opens and closes the front opening of the cabinet 35. The front cassette 31 is detachably provided on the unit body 36.

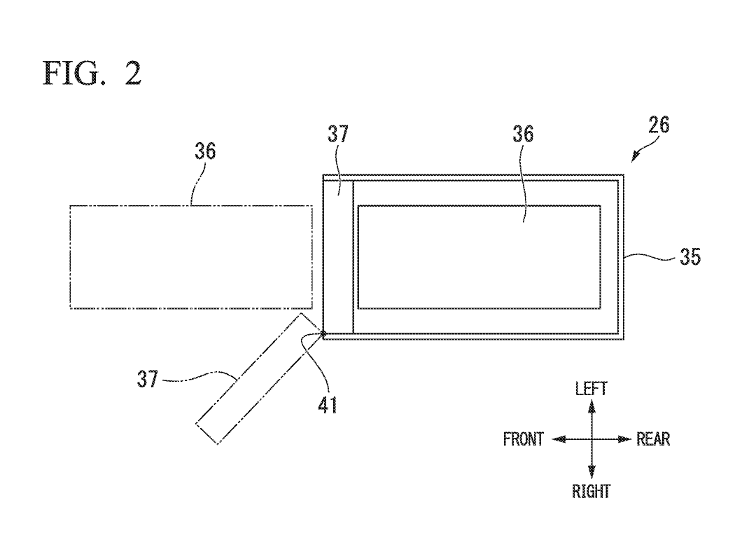

The lid 37 is coupled to one end of the front portion in the horizontal direction in the closed state shown by the solid line in FIG. 2, specifically the one end in the horizontal direction of the cabinet 35 so as to be rotatable centered on a lid rotation axis 41 that extends vertically at a corner position of the right end, specifically, the front end edge portion of the right end. That is, the lid 37 is joined by a hinge to the cabinet 35, and undergoes rotational movement horizontally about the vertical axis. The lid 37 opens to the right.

When in the closed state shown by the solid line in FIG. 2, the lid 37 enters the entire front opening of the cabinet 35 at the inner side thereof and thereby blocks it. Also, upon entering the open state indicated by the two-dot chain line in FIG. 2 from the closed state shown by the solid line in FIG. 2, the lid 37, by being rotated rearward and rightward after being rotated frontward and rightward centered on the lid rotation axis 41, is retracted from the front range of the front portion opening.

The unit body 36 is supported by the right and left inner surfaces of the cabinet 35 via slide rails not illustrated, and is coupled to the cabinet 35 so as to be slidable in the horizontal direction. The unit body 36 is entirely disposed within the cabinet 35 when in a closed state (housed state) of being pushed furthest into the cabinet 35 as shown by the solid lines in FIG. 2. In doing so, a space is formed that allows the lid 37 to enter between the unit body 36 and the front end portion of the cabinet 35. Also, the unit body 36, when pulled out from the cabinet 35, projects frontward from the front portion opening, and when pulled out the most from the cabinet 35 as shown by the two-dot chain line in FIG. 2, is completely outside the cabinet 35. The unit body 36 can be pulled out, that is, an opening actuation becomes possible, only when the lid 37 is in the opened state shown by the two-dot chain line in FIG. 2. That is, the unit body 36 can be pulled out frontward from the cabinet 35 after the lid 37 has entered the opened state by being rotated about the lid rotation shaft 41.

A configuration related to the processing of bills is not provided in the interior of the lid 37. That is, the lid 37 has a structure functioning as a lid that opens and closes the front portion opening of the cabinet 35.

The cabinet 35 and the lid 37 function as a safe for ensuring the security of the front cassette 31 and the eight storage containers 32.

Next, each process in the operation of the paper sheet processing device 10 according to the first embodiment will be described separately.

### (Deposit Process)

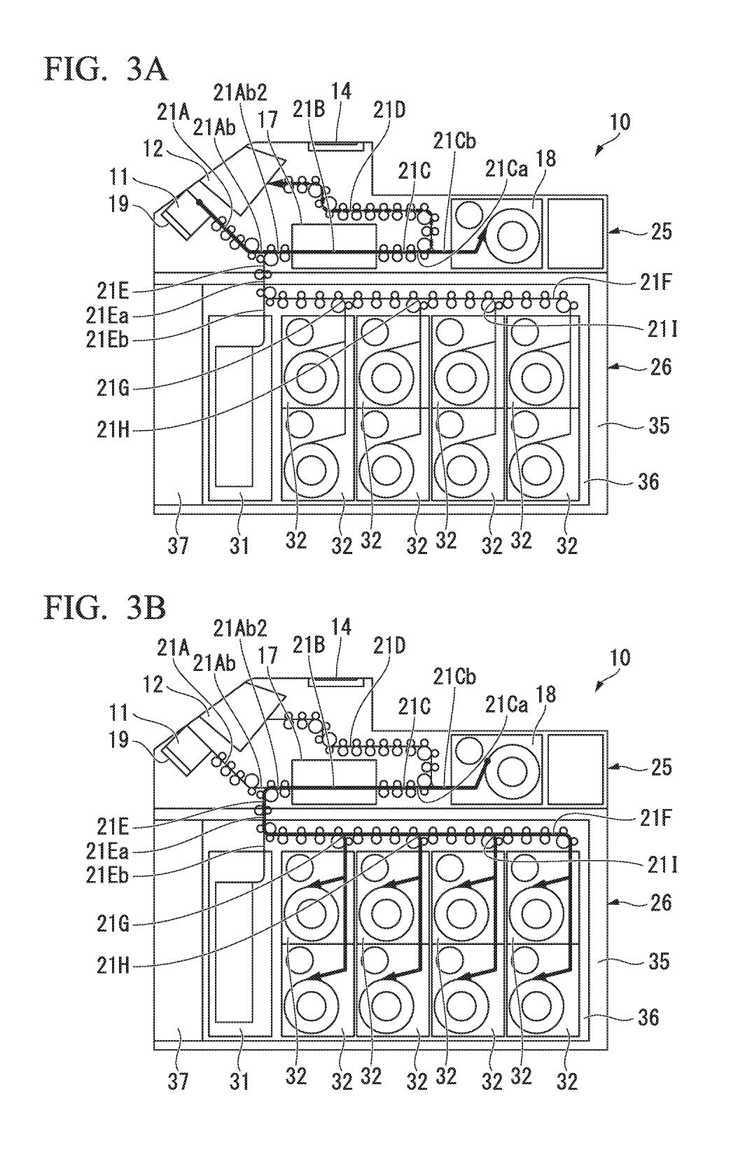

When bills are input from outside to the input unit 11 and an operation for the deposit process start is input to the operation display unit 14, the bills are transported by the deposit process route shown by the heavy lines in FIG. 3A. That is, the input unit 11 separates and feeds the bills one by one, and the deposit transport path 21A, the internal transport path 21B of the identification unit 17, and the front side sending path portion 21Ca of the linear transport path 21C transport the bills that are fed out. During the transport by the internal transport path 21B, the identification unit 17 identifies the bills. The front side sending path portion 21Ca and the rear side sending path portion 21Cb of the linear transport path 21C transport the bills identified as acceptable by the identification unit 17 to the temporary holding unit 18, and the temporary holding unit 18 holds the bills temporarily (refer to the heavy solid line in FIG. 3A). On the other hand, bills identified as unacceptable by the identification unit 17 are transported by the dispensing transport path 21D from the front side sending path portion 21Ca of the linear transport path 21C to the payout unit 12 (refer from the heavy solid line to the heavy broken line of FIG. 3A).

The input unit 11 separates and feeds out bills in a state of being stacked in the thickness direction. For that reason, when fed out from the input unit 11, there is a possibility of transport failure such as overlap and skew arising. Bills with such transport failure are identified as unacceptable by the identification unit 17 and transported to the payout unit 12. When the bills input to the input unit 11 have all been transported to either the temporary holding unit 18 or the payout unit 12, the operation display unit 14 displays the denomination information of the bills temporarily held in the temporary holding unit 18 on the basis of the identification result of the identification unit 17. This money amount information includes the number of bills of each denomination and the total sum. The bills that have been transported to the payout unit 12 become removable to the outside.

### (Organization and Storage Process)

After the money amount information is displayed by the operation display unit 14 in the deposit process, when the operator inputs an approval operation to the operation display unit 14, the bills are transported by the storage process route shown by the heavy lines in FIG. 3B. That is, the temporary holding unit 18 feeds out the bills which had been temporarily held, and the linear transport path 21C, the internal transport path 21B of the identification unit 17, the rear-side constituent portion 21Ab2 of the deposit transport path 21A, the upper side sending path portion 21Ea of the vertical transport path 21E and the storage transport path 21F transport the bills. The identification unit 17 identifies the bills during transport by the internal transport path 21B. Based on the identification result, the storage transport path 21F and the appropriate transport path among the branch transport paths 21G to 21I sort the bills to the corresponding storage containers 32 among the eight storage containers 32. The corresponding storage containers 32 among the eight storage containers 32 store the bills that have been sorted.

The temporary holding unit 18 is a winding-storing type. For this reason, basically transport failures such as overlap or skew do not arise during the feeding operation from the temporary holding unit 18. Thereby, bills that are fed out by the temporary holding unit 18 are basically not judged to be unstorable by the identification unit 17.

### (Return Process)

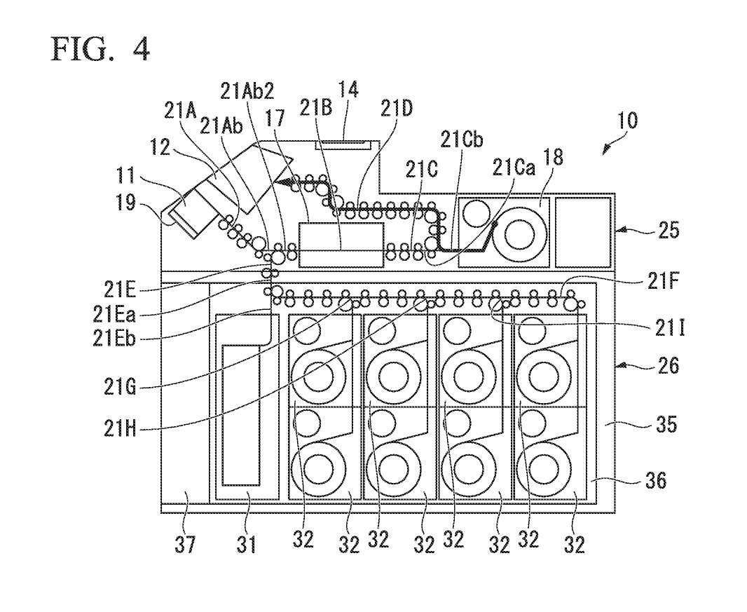

After the money amount information is displayed by the operation display unit 14 in the deposit process, when the operator inputs a return operation to the operation display unit 14, the bills are transported by a return process route shown by the heavy lines in FIG. 4. That is, the bills that had been temporarily held are fed out by the temporary holding unit 18 and transported to the payout unit 12 by the rear side sending path portion 21Cb of the linear transport path 21C and the dispensing transport path 21D. The bills transported to the payout unit 12 become removable to the outside.

### (Arrangement and Counting Process)

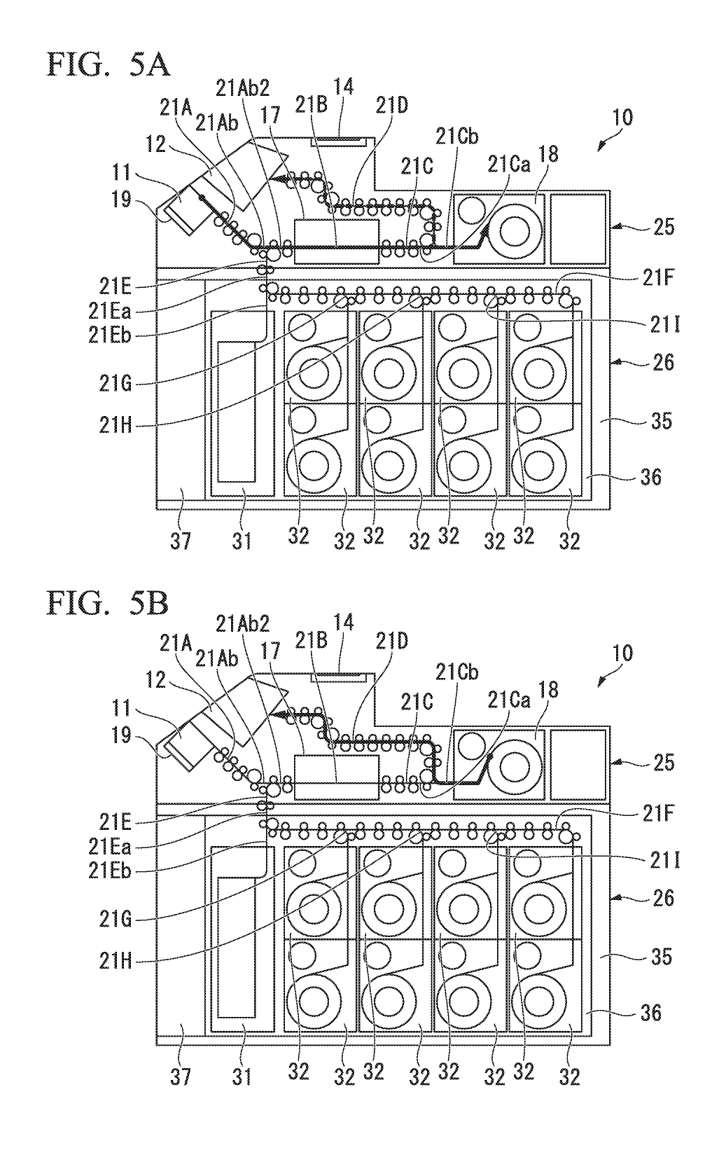

When bills are input from the outside to the input unit 11, a denomination designation is input to the operation display unit 14, and the operation for start of the arrangement and counting process is input, first the bills are transported by the front stage route of the arrangement and counting process shown by the heavy lines in FIG. 5A. That is, the input unit 11 separates and feeds out the bills one at a time, and the bills that have been fed out are transported by the deposit transport path 21A, the internal transport path 21B of the identification unit 17, and the front side sending path portion 21Ca of the linear transport path 21C. During the transport by the internal transport path 21B, the identification unit 17 identifies the bills. The rear side sending path portion 21Cb transports bills that have been identified as bills of a designated denomination by the identification unit 17 from the front side sending path portion 21Ca of the linear transport path 21C to the temporary holding unit 18 to be temporarily held by the temporary holding unit 18 (refer to the heavy solid line of FIG. 5A). On the other hand, the dispensing transport path 21D transports bills that have been identified as being bills other than a designated denomination by the identification unit 17 (including transport failure bills) from the front side sending path portion 21Ca of the linear transport path 21C to the payout unit 12 (refer from the heavy solid line to the heavy dash line of FIG. 5A). The bills transported to the payout unit 12 become removable to the outside.

When the state arises in which all of the bills input to the input unit 11 have been transported to either of the temporary holding unit 18 and the payout portion 12, on the condition of the bills in the payout unit 12 having been taken out, bills are transported by the rear stage route of the arrangement and counting process shown by the heavy line in FIG. 5B. That is, the temporary holding unit 18 feeds out bills temporarily held, and the bills are transported to the payout unit 12 by the rear side sending path portion 21Cb of the linear transport path 21C and the dispensing transport path 21D. On the basis of the identification result by the identification unit 17 in the front stage route, money amount information including the denominations (that is, set denomination), number and total sum of the bills transported to the payout unit 12 are displayed by the operation display unit 14. The bills transported to the payout unit 12 become removable to the outside. Only bills identified as bills of the designated denomination by the identification unit 17 in the front stage route are temporarily held in the temporary holding unit 18. For this reason, the bills transported from the temporary holding unit 18 to the payout unit 12 by the rear stage route are bills corresponding to the identification result by the identification unit 17 in the front stage route. Thereby, there is no need to perform identification with the identification unit 17 in the rear stage route.

### (Dispensing Process)

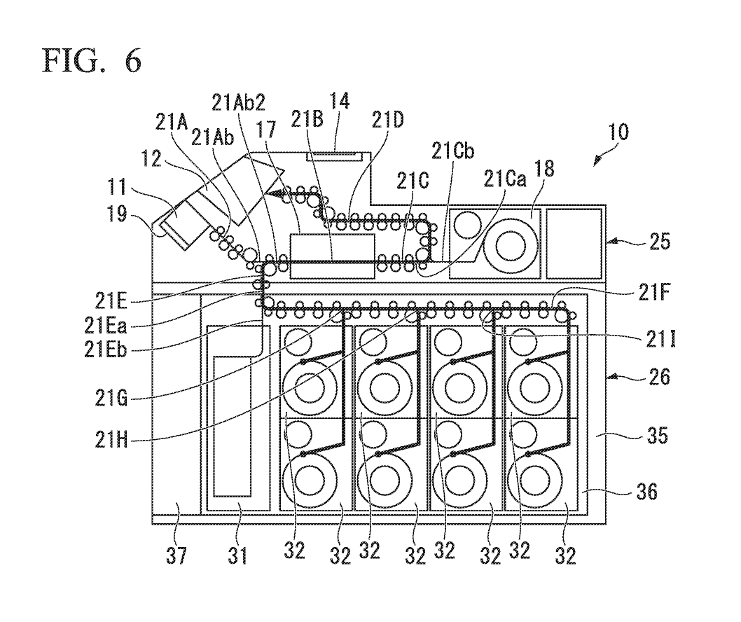

In response to money amount information of bills to be dispensed and a selection operation of the dispensing process being input to the operation display unit 14, when dispensing bills from the storage container 32 set to a single-denomination storage container, bills are transported by the dispensing process route shown by the heavy line in FIG. 6 from the storage container 32 in which bills of the denomination to be dispensed are stored. That is, the storage container 32 corresponding to the denomination to be dispensed among the plurality of storage containers 32 feeds out the bills that are stored while performing counting. Moreover, the bills that are fed out are transported to the payout unit 12 by the appropriate transport path among the branch transport paths 21G to 21I, the storage transport path 21F, the upper side sending path portion 21Ea of the vertical transport path 21E, the rear-side constituent portion 21Ab2 of the deposit transport path 21A, the internal transport path 21B of the identification portion 17, the front side sending path portion 21Ca of the linear transport path 21C, and the dispensing transport path 21D. All of the storage containers 32 are of the winding-storing type. For this reason, when fed out from the storage container 32, transport failures such as overlap and skew due not occur. Thereby, the bills fed out from the storage container 32 are basically not judged to be undispensable by the identification unit 17. The bills transported to the payout unit 12 become removable to the outside.

### (Dispensing Evacuation Process)

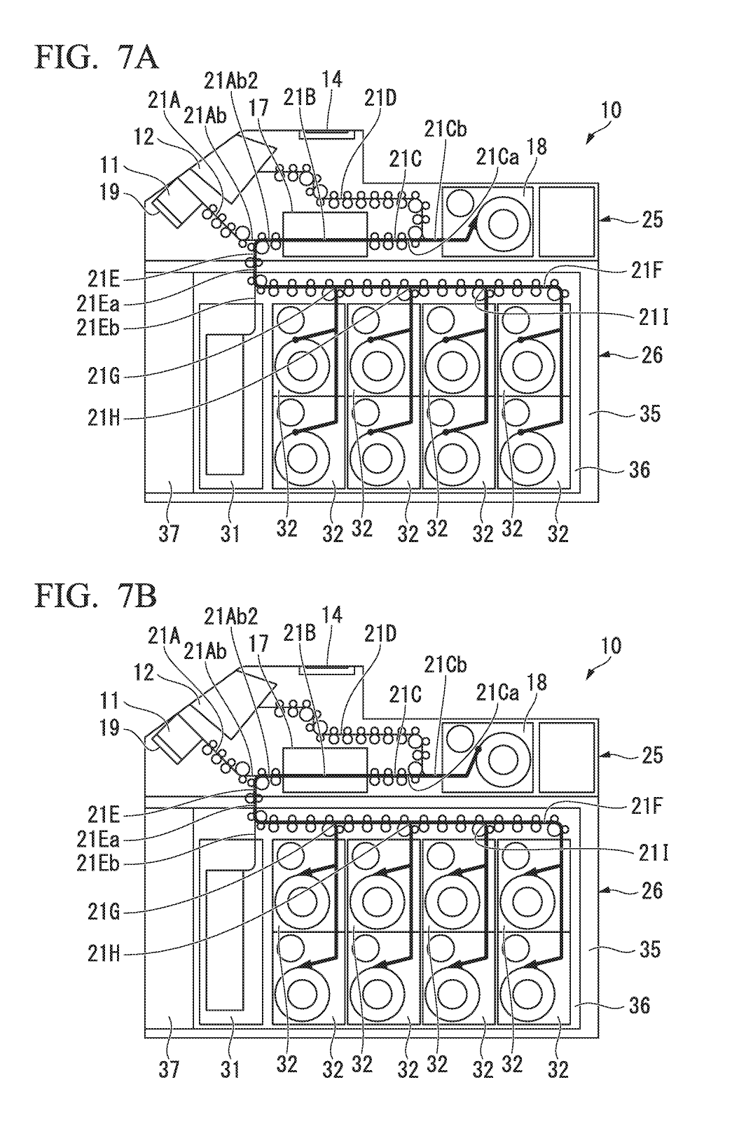

When dispensing bills from the storage container 32 set to a mixed-denomination storage container, the bills of the denomination to be dispensed are transported by the aforementioned dispensing process route, and the bills other than the denomination to be dispensed are transported by the front stage route of the dispensing evacuation process shown by the heavy lines in FIG. 7A. That is, the bills other than those to be dispensed that are fed out from the mixed-denomination storage container 32 are transported to the temporary holding unit 18 by the corresponding transport path among the branch transport paths 21G to 21I, the storage transport path 21F, the upper side sending path portion 21Ea of the vertical transport path 21E, the rear-side constituent portion 21Ab2 of the deposit transport path 21A, the internal transport path 21B of the identification unit 17, and the linear transport path 21C.

When the bills to be dispensed are all been transported to the payout unit 12, next the bills are transported by the rear stage route of the dispensing evacuation process shown by the heavy lines in FIG. 7B. That is, the bills other than those to be dispensed that are temporarily held are fed out by the temporary holding unit 18 and transported by the linear transport path 21C, the internal transport path 21B of the identification unit 17, the rear-side constituent portion 21Ab2 of the deposit transport path 21A, the upper side sending path portion 21Ea of the vertical transport path 21E, and the storage transport path 21F. During transport by the internal transport path 21B, the identification unit 17 identifies the bills. On the basis of the identification result, the storage transport path 21F and the appropriate transport path among the branch transport paths 21G to 21I sort the bills to the corresponding storage container 32 among the eight storage containers 32. The corresponding storage container 32 among the eight storage containers 32 stores the sorted bills.

### (Scrutinization Process)

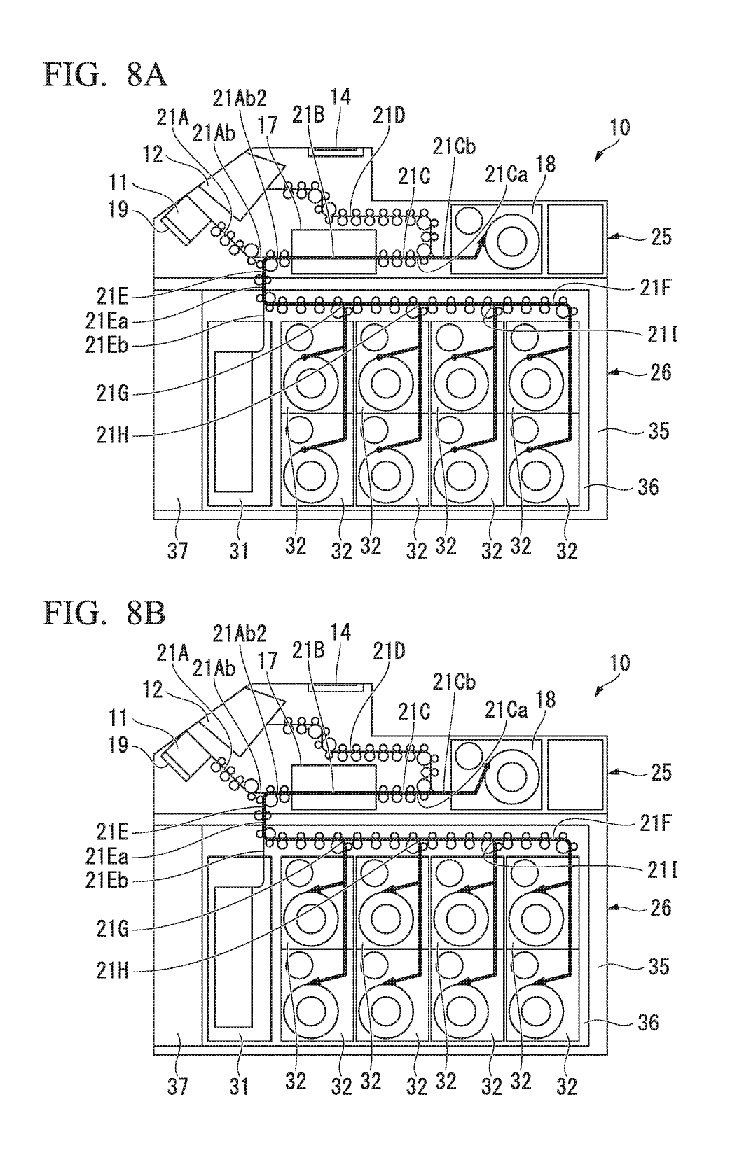

When a selection operation for a scrutinization process is input to the operation display unit 14, first the bills are transported by an outbound route of the scrutinization process indicated by the heavy lines in FIG. 8A. That is, one of the eight storage containers 32 subject to scrutinization feeds out bills. Moreover, the bills that are fed out are transported to the temporary holding unit 18 by the corresponding transport path among the branch transport paths 21G to 21I, the storage transport path 21F, the upper side sending path portion 21Ea of the vertical transport path 21E, the rear-side constituent portion 21Ab2 of the deposit transport path 21A, the internal transport path 21B of the identification unit 17, and the linear transport path 21C. The temporary holding unit 18 temporarily holds the bills. In this way, all of the bills stored in the one storage container 32 subject to scrutinization are transported to the temporary holding unit 18.

Next, the bills are transported on a return route of the scrutinization process indicated by the heavy lines in FIG. 8B. That is, the temporary holding unit 18 feeds out the bills that are temporarily held. Moreover, the bills are transported by the linear transport path 21C, the internal transport path 21B of the identification unit 17, the rear-side constituent portion 21Ab2 of the deposit transport path 21A, the upper side sending path portion 21Ea of the vertical transport path 21E, and the storage transport path 21F. The identification unit 17 identifies the bills during transport by the internal transport path 21B. On the basis of the identification result, the storage transport path 21F and the appropriate transport path among the branch transport paths 21G to 21I transport the bills to the one storage container 32 subject to scrutinization among the eight storage containers 32, and this storage container 32 stores the bills. From the identification result of the identification unit 17 at this time, information of the number of bills stored in the storage container 32 subject to scrutinization, that is, the money amount information, is confirmed.

The same process as the aforementioned is performed for each of the storage containers 32 subject to scrutinization, whereby the money amount information of each one of the storage containers 32 subject to scrutinization is confirmed.

### (Cassette Replenishment Process)

When performing a cassette replenishment operation, bills are stored in the front cassette 31 outside the device. The lid 37 is then opened, the unit body 36 is pulled out from the cabinet 35, and this front cassette 31 is attached to the unit body 36 by replacing the front cassette 31 that had been attached thereto.

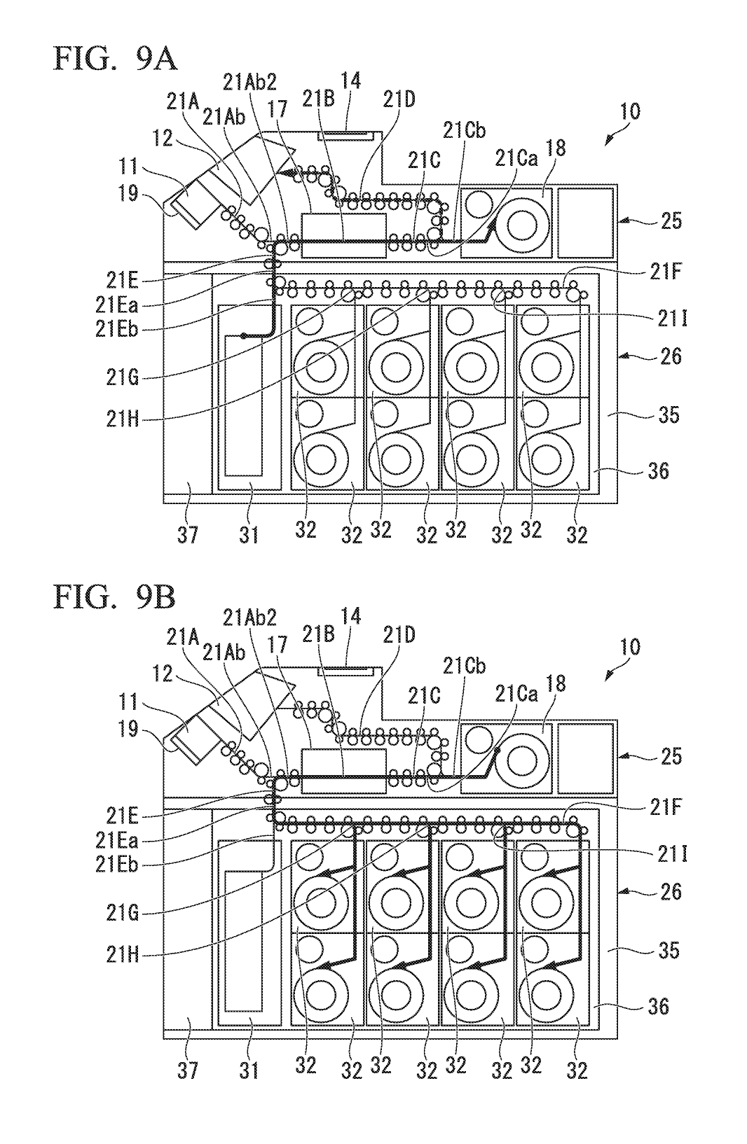

When the selection operation for a cassette replenishment operation is input to the operation display unit 14, bills are transported by the front stage route of the cassette replenishment operation indicated by the heavy lines in FIG. 9A. That is, the front cassette 31 feeds out bills and the fed out bills are transported by vertical transport path 21E, the rear-side constituent portion 21Ab2 of the deposit transport path 21A, the internal transport path 21B of the identification unit 17, and front side sending path portion 21Ca of the linear transport path 21C. The identification unit 17 identifies the bills during transport by the internal transport path 21B. On the basis of the identification result, the bills that are identified as acceptable are transported by the rear side sending path portion 21Cb of the linear transport path 21C to the temporary holding unit 18 to be temporarily held by the temporary holding unit 18 (refer to the heavy solid line of FIG. 9A). The front cassette 31 is a stacking-storing type. For that reason, there is a possibility of transport failure such as overlap and skew of the bills fed out from the front cassette 31. Bills identified as unacceptable including such transport failure bills are transported by the dispensing transport path 21D from the front side sending path portion 21Ca of the linear transport path 21C to the payout unit 12 (refer from the heavy solid line to the heavy broken line in FIG. 9A). The bills that have been transported to the payout unit 12 become removable to the outside.

The storage capacity of the front cassette 31 is larger than the storage capacity of the temporary holding unit 18. For this reason, the temporary holding unit 18 may fill up prior to the front cassette 31 becoming empty. If the front cassette 31 becomes empty or the temporary holding unit 18 fills up, bills will be transported by the rear stage route of the cassette replenishment process shown by the heavy lines in FIG. 9B. That is, the temporary holding unit 18 feeds out the bills which had been temporarily held, and the linear transport path 21C, the internal transport path 21B of the identification unit 17, the rear-side constituent portion 21Ab2 of the deposit transport path 21A, the upper side sending path portion 21Ea of the vertical transport path 21E and the storage transport path 21F transport the bills. The identification unit 17 identifies the bills during transport by the internal transport path 21B. Based on the identification result, the storage transport path 21F and the appropriate transport path among the branch transport paths 21G to 21I sort the bills to the corresponding storage containers 32 among the eight storage containers 32. The corresponding storage containers 32 among the eight storage containers 32 store the bills that have been sorted.

The above process is suitably repeated until the front cassette 31 becomes empty. By doing so, the bills stored in the front cassette 31 are sorted in the corresponding storage containers 32 among the eight storage containers 32 and stored.

### (Deposit Port Replenishment Process)

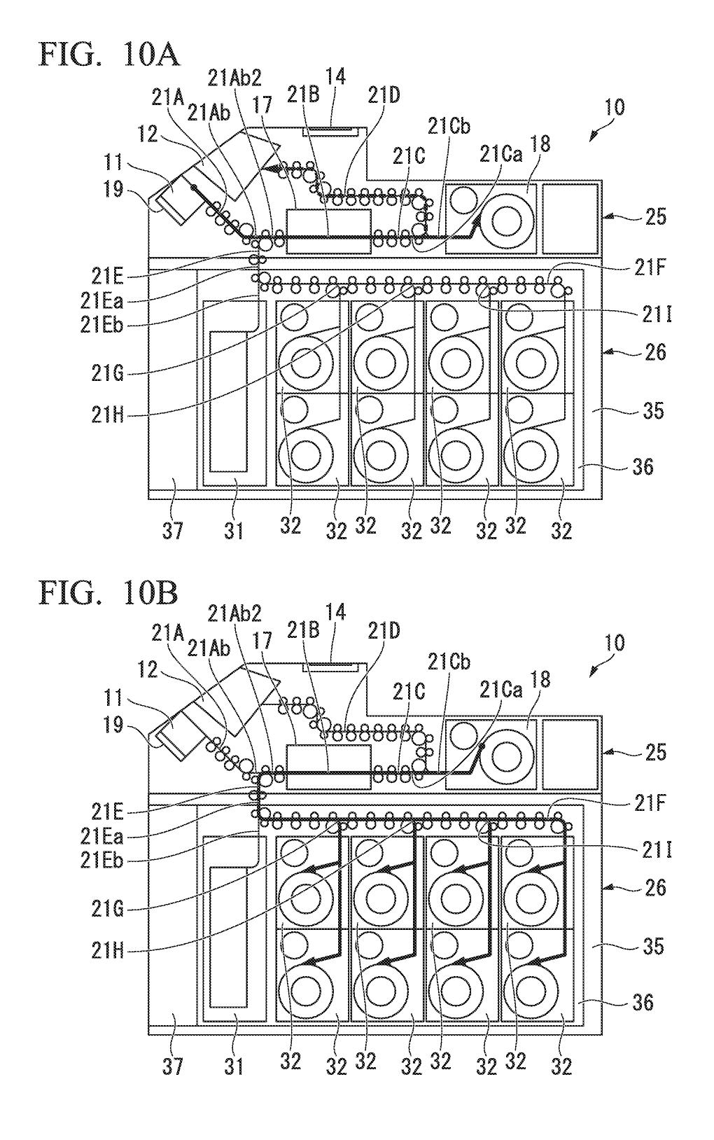

When the selection operation for the deposit port replenishment process is input to the operation display unit 14, first, bills are transported by the front stage route of the deposit port replenishment process shown by the heavy lines in FIG. 10A. That is, the input unit 11 separates and feeds out the bills one by one. Moreover, the deposit transport path 21A, the internal transport path 21B of the identification unit 17, and front side sending path portion 21Ca of the linear transport path 21C transport the bills that have been fed out. The identification unit 17 identifies the bills during transport by the internal transport path 21B. The front side sending path portion 21Ca and the rear side sending path portion 21Cb of the linear transport path 21C transport the bills identified as acceptable by the identification unit 17 to the temporary holding unit 18, and the temporary holding unit 18 temporarily holds the bills (refer to the heavy lines in FIG. 10A). On the other hand, the dispensing transport path 21D transports bills identified as unacceptable by the identification unit 17 (including transport failure bills) from the front side sending path portion 21Ca of the linear transport path 21C to the payout unit 12 (refer from the heavy solid line to the heavy broken line in FIG. 10A). The bills that have been transported to the payout unit 12 become removable to the outside.

When the state arises in which all of the bills input to the input unit 11 have been transported to either of the temporary holding unit 18 and the payout portion 12, the bills are transported by the rear stage route of the deposit port replenishment process indicated by the heavy lines in FIG. 10B. That is, the temporary holding unit 18 feeds out bills temporarily held. The linear transport path 21C, the internal transport path 21B in the identification unit 17, the rear-side constituent portion 21Ab2 of the deposit transport path 21A, the upper side sending path portion 21Ea of the vertical transport path 21E, and the storage transport path 21F transport the bills. The identification unit 17 identifies the bills during transport by the internal transport path 21B. On the basis of the identification result, the storage transport path 21F and the appropriate transport path among the branch transport paths 21G to 21I sort the bills to the corresponding storage containers 3 among the eight storage containers 32. The corresponding storage containers 32 among the eight storage containers 32 store the sorted bills. By doing so, the bills input to the input unit 11 are sorted to the corresponding storage containers 32 among the eight storage containers 32 and stored.

### (Collection Process)

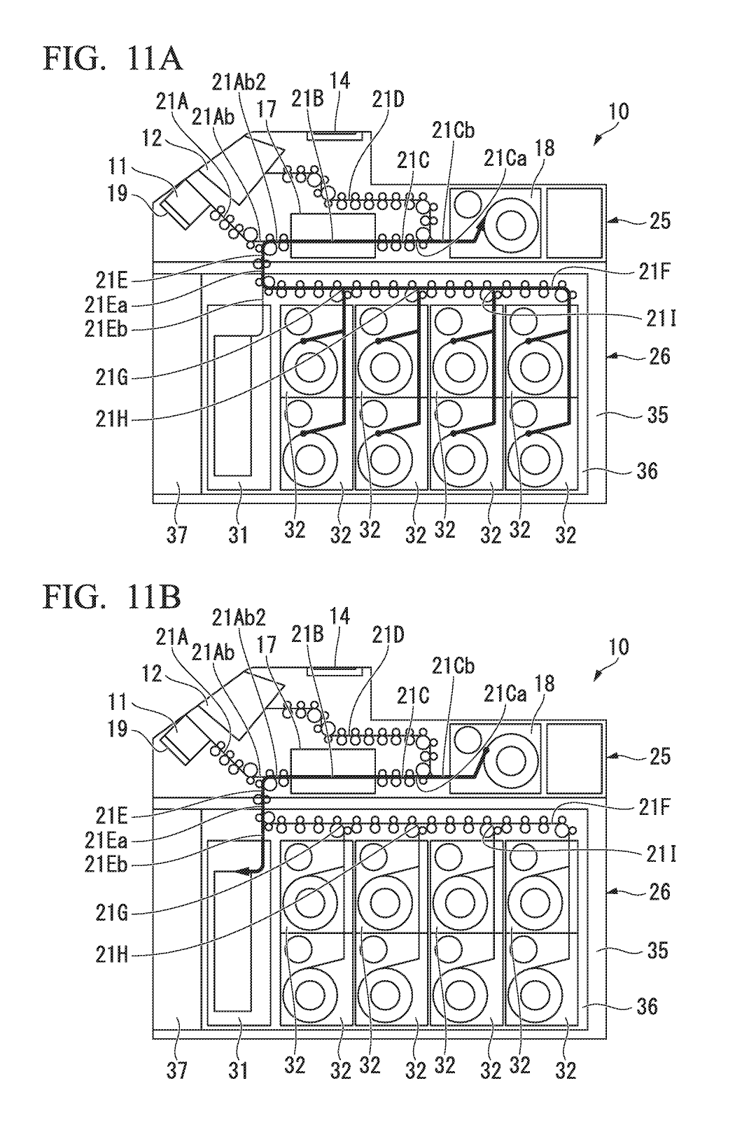

When a selection operation for a collection process is input to the operation display unit 14, bills are transported by the front stage of the collection process shown by the heavy lines in FIG. 11A. That is, one storage container 32 among the eight storage containers 32 feeds out the bills. Moreover, the appropriate transport path among the branch transport paths 21G to 21I, the storage transport path 21F, the upper side sending path portion 21Ea of the vertical transport path 21E, the rear-side constituent portion 21Ab2 of the deposit transport path 21A, the internal transport path 21B of the identification unit 17, and the linear transport path 21C transport the bills that have been fed out to the temporary holding unit 18, and the temporary holding unit 18 temporarily holds the bills. By doing so, all of the bills of the one storage container 32 to be collected are transported to the temporary holding unit 18.

Next, the bills are transported by the rear stage route of the collection process shown by the heavy lines in FIG. 11B. That is, the temporary holding unit 18 feeds out the bills that have been temporarily held. Moreover, the linear transport path 21C, the internal transport path 21B of the identification unit 17, the rear-side constituent portion 21Ab2 of the deposit transport path 21A, and the vertical transport path 21E transport the bills to the front cassette 31, and the front cassette 31 stores the bills.

Such a process is performed on a storage container 32 for which collection has been designated among the plurality of storage containers 32 (in some cases all of the storage containers 32 are designated). Afterward, the lid 37 is opened, and the unit body 36 is pulled out from the cabinet 35, whereby the front cassette 31 is taken out from the unit body 36.

According to the first embodiment described above, the identification unit 17 and the temporary holding unit 18 are connected by the linear transport path 21C forming a straight line, and the bills are transported to the temporary holding unit 18 by the linear transport path 21C after identification by the identification unit 17. For this reason, the bills are not transported from the identification unit 17 to the temporary holding unit 18 in a curved state. Accordingly, it is possible to inhibit the occurrence of jamming. Furthermore, also in the case of the bills being transported from the temporary holding unit 18 to the identification unit 17, the bills are transported by the linear transport path 21C. For this reason, the bills are not transported from the temporary holding unit 18 to the identification unit 17 in a curved state. Accordingly, it is possible to inhibit the occurrence of jamming.

Also, the linear transport path 21C extends in the horizontal direction and connects the identification unit 17 and the temporary holding unit 18, whose positions are overlapped (agreeing) in the height direction. For this reason, it is possible to shorten the length in the height direction of the paper sheet processing device 10, and it is possible to achieve an overall reduction in size of the paper sheet processing device 10.

The input unit 11 that feeds input bills toward the identification unit 17, the identification unit 17 that identifies bills that have been fed from the input unit 11, and the temporary holding unit 18 to which the bills are transported by the linear transport path 21C after identification by the identification unit 17 are arranged in this order from the front of the paper sheet processing device 10 to the rear of the paper sheet processing device 10. For this reason, the input unit 11 is not stacked above or below the identification unit 17 and the temporary holding unit 18. Thereby, it is possible to shorten the length of the paper sheet processing device 10 in the height direction, and it becomes possible to achieve an overall reduction in size of the paper sheet processing device 10.

Also, since the paper sheets to be processed in the paper sheet processing device 10 are bills, it is possible to inhibit the occurrence of jamming of bills.

There is no restriction on the eight of the storage containers 32. Seven or fewer storage containers 32 may be provided, and nine or more may be provided. Also, there is no restriction with regard to providing the storage containers 32, 32 of two stages that are vertically arranged over a plurality of rows. The storage container 32 of one stage may be provided over a plurality of rows.

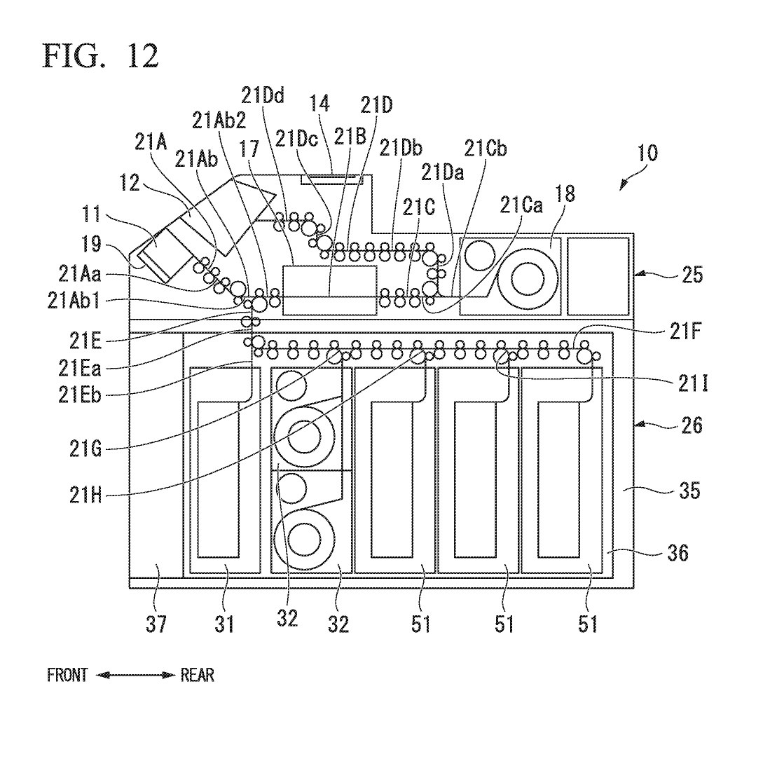

A paper sheet processing device according to a second embodiment of the present invention will be described below centered on the differences with the first embodiment, referring mainly to FIG. 12 to FIG. 16B. In the second embodiment, in addition to a total of six storage containers 32 in two stages arranged vertically in three rows on the rear side among the eight storage containers 32 of the first embodiment, three storage containers 51 are provided. The height of the storage containers 51 is the same as the height of two storage containers 32. The positions of the three storage containers 51 are overlapped (agreeing) in the height direction with the storage containers 32 that of two vertically arranged stages.

Each of the three storage containers 51 can take in and store bills one by one, and can feed out bills that are stored one by one. The three storage containers 51 are each of the stacking-storing type that performs storage by taking in bills from the upper portion and stacking the bills in a horizontal state from bottom to top, and feeds out the stored bills from the bill at the upper end portion. For this reason, when feeding out bills from the three storage containers 51, there is a possibility of transport failure such as overlap and skew in the bills being fed out. In the second embodiment, the transportation route in that case differs from that of the first embodiment. The storage container 51 of the stacking-storing type has a substantially higher bill storing efficiency compared with a winding-storing type such as the temporary holding unit 18 and the storage container 32. The storage capacities of the three storage containers 51 are the same as each other. The storage capacity of each storage container 51 is the same as the front cassette 31.

In the second embodiment, the two storage containers 32 are set as mixed-denomination storage containers, and the three storage containers 51 are set as single-denomination storage containers. Although arbitrary setting of a single-denomination storage container and a mixed-denomination storage container is possible, it is preferable to set the three storage containers 51 as single-denomination storage containers.

Next, each process of the operation of the paper sheet processing device 10 according to the second embodiment will be described separately.

### (Deposit Process)

By the same route as the deposit process route shown by the heavy lines in FIG. 3A of the first embodiment, the bills that are input to the input unit 11 are identified by the identification unit 17, the bills that are identified as acceptable are temporarily held in the temporary holding unit 18 (refer to the heavy solid line of FIG. 3A), and the bills that are identified as unacceptable (including transport failure bills) are transported to the payout unit 12 (refer from the heavy solid line to the heavy broken line of FIG. 3A).

### (Storage Process)

By the same route as the storage process route shown by the heavy lines in FIG. 3B of the first embodiment, the bills temporarily held in the temporary holding unit 18 are identified by the identification unit 17 and on the basis of that result stored in a corresponding one of the upper and lower two storage containers 32 and the three storage containers 51.

### (Return Process)

By the same route as the return process route shown by the heavy line in FIG. 4 of the first embodiment, the bills temporarily held in the temporary holding unit 18 are transported to the payout unit 12.

### (Arrangement and Counting Process)

By the same route as the front stage route of the arrangement and counting process shown by the heavy lines in FIG. 5A of the first embodiment, the bills that are input to the input unit 11 are identified by the identification unit 17, the bills that are identified as a designated denomination are temporarily held in the temporary holding unit 18 (refer to the heavy solid line of FIG. 5A), and the bills that are identified as being other than the designated denomination (including transport failure bills) are transported to the payout unit 12 (refer from the heavy solid line to the heavy broken line of FIG. 5A). Next, by the same route as the rear stage route of the arrangement and counting process shown by the heavy lines in FIG. 5B of the first embodiment, the bills that are temporarily held in the temporary holding unit 18 are transported to the payout unit 12, and the identification result of the identification unit 17 for the bills made to be temporarily held in the temporary holding unit 18 by the front stage route is displayed in the operation display unit 14.

### (Dispensing Process)

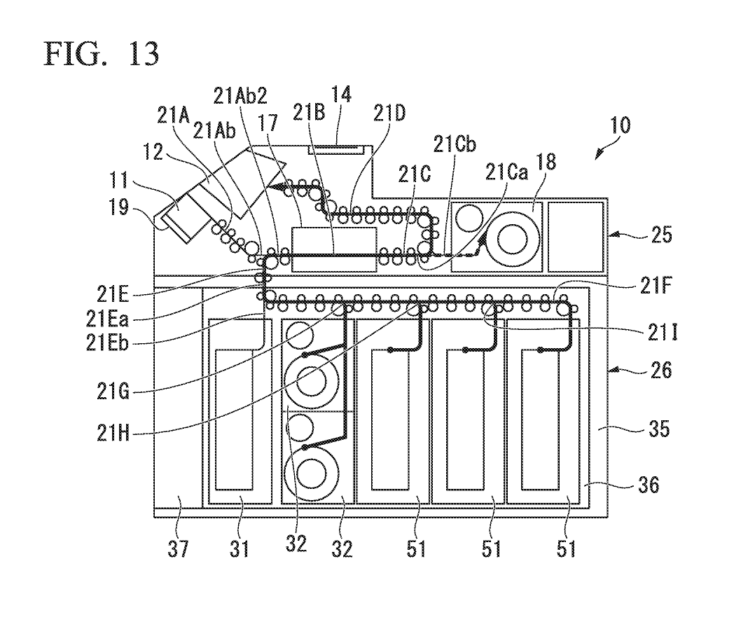

When the money amount information of bills to be dispensed and a selection operation for the dispensing process are input, bills are transported by the dispensing process route shown by the heavy line in FIG. 13 from a storage container in which are stored the bills of the denomination to be dispensed among the two storage containers 32 and the three storage containers 51. That is, the corresponding storage containers among the two storage containers 32 and the three storage containers 51 feed out the bills that are stored therein. Moreover, the appropriate transport path among the branch transport paths 21G to 21I, the storage transport path 21F, the upper side sending path portion 21Ea of the vertical transport path 21E, the rear-side constituent portion 21Ab2 of the deposit transport path 21A, the internal transport path 21B of the identification unit 17, and the front side sending path portion 21Ca of the linear transport path 21C transport the bills that have been fed out. The bills that are identified by the identification unit 17 during transport by the internal transport path 21B and judged to be dispensable by the identification unit 17 are transported by the dispensing transport path 21D to the payout unit 12 (refer to the heavy solid line of FIG. 13).

Since the three storage containers 51 are of the stacking-storing type, when the bills are fed out from the storage container 51, there is a possibility of transport failure such as overlap and skew occurring. Such transport failure bills are judged as undispensable by the identification unit 17, whereby the rear side sending path portion 21Cb of the linear transport path 21C transports the bills to the temporary holding unit 18, and the temporary holding unit 18 temporarily holds the bills (refer from the heavy solid line to the heavy broken line of FIG. 13). The two storage containers 32 of the winding-storing type are set as mixed-denomination storage containers. For this reason, the storage container 32, when feeding out, sometimes feed out bills other than the denomination to be dispensed. Such bills identified by the identification unit 17 as being other than the denomination to be dispensed are transported to the temporary holding unit 18 by the rear side sending path portion 21Cb of the linear transport path 21C to be temporarily held by the temporary holding unit 18 bills (refer from the heavy solid line to the heavy broken line of FIG. 13). Afterward, when all the bills to be dispensed are transported to the payout unit 12, the bills temporarily held in the temporary holding unit 18 are identified by the identification unit 17. On the basis of the identification result, the bills are stored in the corresponding storage containers among the two storage containers 32 and the three storage containers 51. For example, a normal transport bill is stored in the storage container 51 set so as to store a denomination corresponding to the denomination of that bill. Transport failure bills are stored in the appropriate storage container 32 among the two storage containers 32 with mixed-denominations.

### (Scrutinization Process)

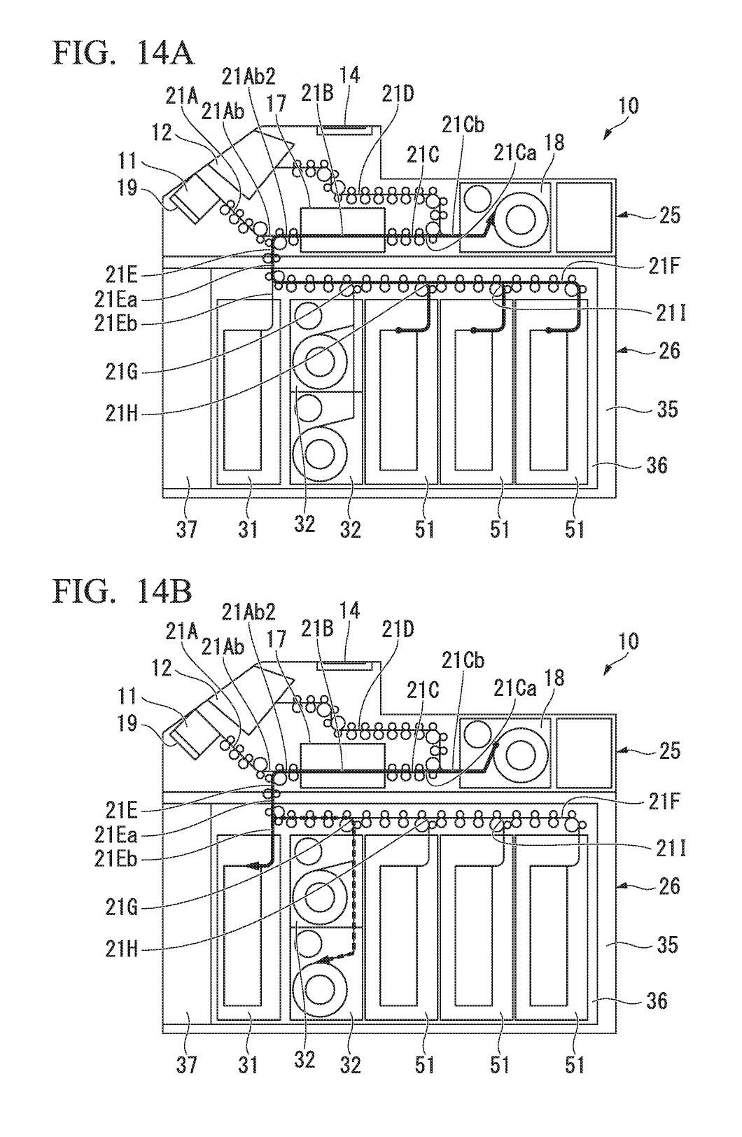

Since there is the possibility of the two winding-storing type storage containers 32 that are vertically arranged storing transport failure bills, such bills are not subject to scrutinization. The three storage containers 51 of the stacking-storing type set as single-denomination storage containers are subject to scrutinization. Bills are transported from the storage container 51 subject to scrutinization among the storage containers 51 by the front stage route of the outbound process of the scrutinization process shown by the heavy lines in FIG. 14A. That is, one of the storage containers 51 subject to scrutinization feeds out the bills. Moreover, the appropriate transport path among the branch transport paths 21H to 21I, the storage transport path 21F, the upper side sending path portion 21Ea of the vertical transport path 21E, the rear-side constituent portion 21Ab2 of the deposit transport path 21A, the internal transport path 21B of the identification unit 17, and the linear transport path 21C transport the bills that have been fed out to the temporary holding unit 18, and the temporary holding unit 18 temporarily holds the bills. At this time there may also be bills that become transport failure bills due to being fed out from the stacking-storing type storage container 51. Such transport failure bills are temporarily held in the temporary holding unit 18 as is.

When the storage container 51 subject to scrutinization becomes empty, or the temporary holding unit 18 becomes full, the bills are transported by the rear stage route of the outbound process of the scrutinization process shown by the heavy lines in FIG. 14B. That is, the temporary holding unit 18 feeds out the bills that are temporarily held. Moreover, the linear transport path 21C, the internal transport path 21B of the identification unit 17, the rear-side constituent portion 21Ab2 of the deposit transport path 21A, and the upper side sending path portion 21Ea of the vertical transport path 21E transport the bills. The identification unit 17 identifies the bills during transport by the internal transport path 21B. The lower side sending path portion 21Eb of the vertical transport path 21E transports bills of the denomination subject to scrutinization to the front cassette 31, and the front cassette 31 stores the bills (refer to the heavy solid line in FIG. 14B). The storage transport path 21F and the branch transport path 21G transport the bills of denominations other than that subject to scrutinization (including transport failure bills) to the storage container 32 set as the mixed-denomination storage container, and this storage container 32 stores the bills (refer from the heavy solid line to the heavy broken line of FIG. 14B).

The outbound process of the aforementioned scrutinization process is appropriately repeated until the storage container 51 subject to scrutinization becomes empty.

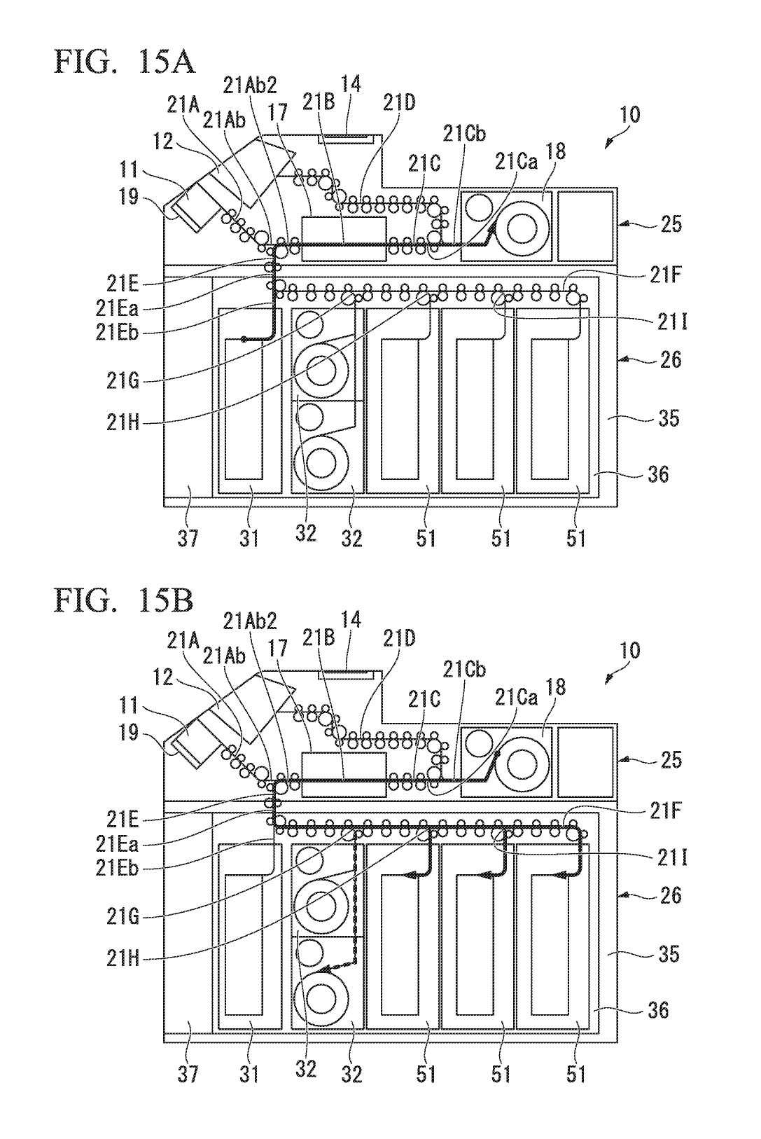

Next, the bills are transported by the front stage route of the return process of the scrutinization process shown by the heavy lines in FIG. 15A. That is, the front cassette 31 feeds out the bills. Moreover, the vertical transport path 21E, the rear-side constituent portion 21Ab2 of the deposit transport path 21A, the internal transport path 21B of the identification unit 17, and the linear transport path 21C transport the bills that have been fed out to the temporary holding unit 18, and the temporary holding unit 18 temporarily holds the bills. At this time there may also be bills that become transport failure bills due to being fed out from the stacking-storing type front cassette 31. Such transport failure bills are temporarily held in the temporary holding unit 18 as is.

When the front cassette 31 becomes empty, or the temporary holding unit 18 becomes full, the bills are transported by the rear stage route of the return process of the scrutinization process shown by the heavy lines in FIG. 15B. That is, the temporary holding unit 18 feeds out the bills that are temporarily held, and the linear transport path 21C, the internal transport path 21B of the identification unit 17, the rear-side constituent portion 21Ab2 of the deposit transport path 21A, the upper side sending path portion 21Ea of the vertical transport path 21E, and the storage transport path 21F transport the bills. The identification unit 17 identifies the bills during transport by the internal transport path 21B. On the basis of the identification result, the storage transport path 21F and the appropriate transport path among the branch transport paths 21H to 21I transport the bills subject to scrutinization to the one storage container 51 subject to scrutinization among the three storage containers 51, and this storage container 51 stores the bills (refer to the heavy solid line of FIG. 15B). The storage transport path 21F and the branch transport path 21G transport the bills of denominations other than that subject to scrutinization (including transport failure bills) to the storage container 32 set as the mixed-denomination storage container, and this storage container 32 stores the bills (refer from the heavy solid line to the heavy broken line of FIG. 15B).

The return process of the aforementioned scrutinization process is appropriately repeated until the front cassette 31 becomes empty. From the identification result of the identification unit 17 in the rear stage route during the return process of the scrutinization process, information of the number of bills stored in the storage container 51 subject to scrutinization, that is, the money amount information, is confirmed.

The same process as the aforementioned is performed for each of the storage containers 51 subject to scrutinization, whereby the money amount information of each one of the storage containers 51 subject to scrutinization is confirmed.

### (Cassette Replenishment Process)

By the same route as the front stage route of the cassette replenishment process shown by the heavy line in FIG. 9A of the first embodiment, bills fed out from the front cassette 31 are identified by the identification unit 17, and on the basis of the identification result, the bills identified as acceptable are temporarily held in the temporary holding unit 18 (refer to the heavy solid line in FIG. 9A), while the bills identified as unacceptable by the identification unit 17 are transported to the payout unit 12 (refer from the heavy solid line to the heavy broken line in FIG. 9A).

When the front cassette 31 becomes empty, or the temporary holding unit 18 becomes full, the bills are transported by the same route as the rear stage route of the cassette replenishment process shown by the heavy line in FIG. 9B of the first embodiment. That is, the bills temporarily held in the temporary holding unit 18 are identified by the identification unit 17, and based on the identification result, the bills are sorted to the corresponding storage container 51 among the three storage containers 51 set as single-denomination storage containers. The aforementioned process is appropriately repeated until the front cassette 31 becomes empty.

### (Deposit Port Replenishment Process)

By the same route as the front stage route of the deposit port replenishment process shown by the heavy line in FIG. 10A of the first embodiment, bills input to the input unit 11 are identified by the identification unit 17. Bills identified as acceptable by the identification unit 17 are temporarily held in the temporary holding unit 18 (refer to the heavy lines in FIG. 10A), while bills identified as unacceptable by the identification unit 17 are transported to the payout unit 12 (refer from the heavy solid line to the heavy broken line in FIG. 10A).

Next, by the same route as the rear stage route of the deposit port replenishment process shown by the heavy line in FIG. 10B of the first embodiment, bills that are temporarily held in the temporary holding unit 18 are identified by the identification unit 17. Based on that identification result, the bills are sorted to the corresponding storage container among the two storage containers 32 and the three storage containers 51.

### (Collection Process)

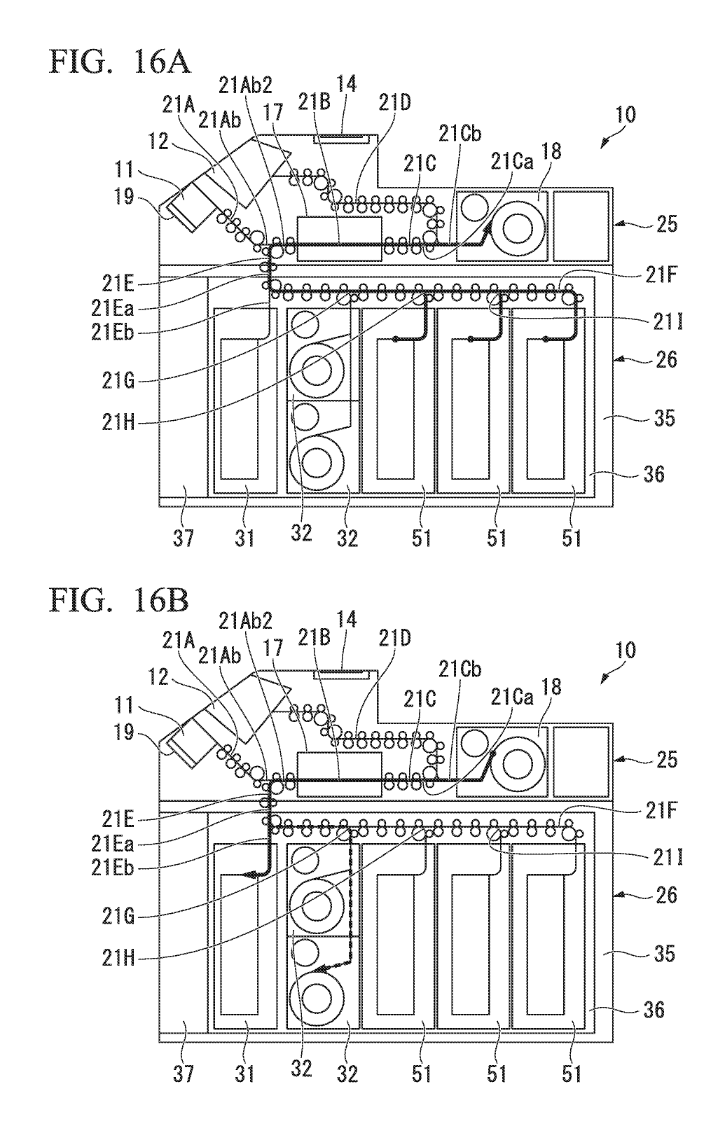

Bills are transported by the front stage route of the collection process indicated by the heavy lines in FIG. 16A. That is, one storage container subject to collection among the three storage containers 51 set as single-denomination storage containers feeds out the bills, and the bills that have been fed out are transported by the same route as the first embodiment to be temporarily held in the temporary holding unit 18. At this time, some bills become transport failure bills due to being fed out from the stacking-storing type storage container 51. Such transport failure bills are also made to be temporarily held in the temporary holding unit 18 as is.

When the storage container 51 subject to collection becomes empty, or the temporary holding unit 18 becomes full, the bills are transported by the rear stage route of the collection process shown by the heavy lines in FIG. 16B. That is, the temporary holding unit 18 feeds out the bills that are temporarily held. Moreover, the linear transport path 21C, the internal transport path 21B of the identification unit 17, the rear-side constituent portion 21Ab2 of the deposit transport path 21A, and the upper side sending path portion 21Ea of the vertical transport path 21E perform transport. The identification unit 17 identifies the bills during transport by the internal transport path 21B. On the basis of the identification result, the lower side sending path portion 21Eb of the vertical transport path 21E transports bills subject to collection to the front cassette 31, and the front cassette 31 stores the bills (refer to the heavy solid line in FIG. 16B). The storage transport path 21F and the branch transport path 21G transport the bills other than those subject to collection (including transport failure bills) to the storage container 32 set as the mixed-denomination storage container, and this storage container 32 stores the bills (refer from the heavy solid line to the heavy broken line of FIG. 16B).

The aforementioned process is appropriately repeated until the storage container 51 subject to collection becomes empty. Thereafter, the lid 37 is opened, and the unit body 36 is pulled out from the cabinet 35, whereby the front cassette 31 is removed from the unit body 36. Depending on the total quantity of bills in the plurality of storage containers 51, it is also possible to once store the bills of the storage containers 51 in the front cassette 31 for collection.

The bills stored in the storage container 32 set as the mixed-denomination storage container are transported to the payout unit 12 by the same route as the dispensing process and removed.

There is no restriction on the three of the storage containers 51. Two or fewer storage containers 51 may be provided, and four or more may be provided. Also, there is no restriction with regard to providing the storage containers 32 in two stages that are vertically arranged in one row. The storage containers 32 may be provided in two stages over two or more rows. Furthermore, there is no restriction with regard to providing the storage containers 32, 32 of two stages that are vertically arranged in one row or a plurality of rows. The storage container 32 of one stage may be provided in one row or a plurality of rows.

A paper sheet processing device according to an embodiment of the present invention includes: an identification unit that identifies a paper sheet; a temporary holding unit that temporarily holds the identified paper sheet; and a linear transport path that connects the identification unit and the temporary holding unit, extends in a straight line, and transports the paper sheet identified by the identification unit to the temporary holding unit. In the aforementioned paper sheet processing device, a position of the identification unit in a height direction agrees with a position of the temporary holding unit in the height direction, and the linear transport path extends in a lateral direction.

According to the aforementioned paper sheet processing device, the identification unit and the temporary holding unit, whose positions agree in the height direction, are connected by the linear transport path extending in the horizontal direction. For this reason, it is possible to shorten the length of the device in the height direction, and it is possible to achieve an overall reduction in size of the device.

The aforementioned paper sheet processing device further includes: an input unit in which a paper sheet is input and that feeds the input paper sheet toward the identification unit, the identification unit identifies the input paper sheet, the linear transport path transports the input and identified paper sheet to the temporary holding unit, and the input unit, the identification unit, and the temporary holding unit are arranged in order of the input unit, the identification unit, and the temporary holding unit heading from front of the paper sheet processing device to rear of the paper sheet processing device.

According to the aforementioned paper sheet processing device, the input unit that feeds a paper sheet that has been input toward the identification unit, the identification unit that identifies the paper sheet that have been fed from the input unit, and the temporary holding unit to which the paper sheet after identification by the identification unit has been transported by the linear transport path are arranged in this order from the front of the device. For this reason, the input unit is not vertically stacked on the identification unit and the temporary holding unit. Thereby, it is possible to shorten the length of the device in the height direction, and it is possible to achieve an overall reduction in size of the device.

In the aforementioned paper sheet processing device, the paper sheet is a bill.

In the aforementioned paper sheet processing device, since the paper sheet to be processed is a bill, it is possible to inhibit the occurrence of jamming of bills.

### INDUSTRIAL APPLICABILITY

The present invention may be applied to a paper sheet processing device.

### REFERENCE SYMBOLS

10: Paper sheet processing device
11: Input unit
17: Identification unit
18: Temporary holding unit
21C: Linear transport path

1. A paper sheet processing device comprising:
an identification unit that identifies a paper sheet;
a temporary holding unit that temporarily holds the identified paper sheet;
a linear transport path that connects the identification unit and the temporary holding unit, extends in a straight line, and transports the paper sheet identified by the identification unit to the temporary holding unit;
a payout unit that makes the identified and temporarily held paper sheet be capable of being removed to an outside; and
a dispensing transport path that branches upward from an intermediate position of the linear transport path, connected with the payout unit, and transports the identified and temporarily held paper sheet to the payout unit,
wherein the payout unit, the identification unit, and the temporary holding unit are arranged horizontally in this order and are not overlapped with each other when seen from a vertical direction.

2.-8. (canceled)

9. The paper sheet processing device according to claim 1, further comprising:
an input unit in which a paper sheet is input; and
a first transportation path that is connected with the input unit, and transports the paper sheet that has been input in the input unit to the identification unit,
wherein the first transportation path is provided downward toward rear from front toward rear of the paper sheet processing device.

10. The paper sheet processing device according to claim 9, wherein each of the input unit and the payout unit is provided downward toward rear from front toward rear of the paper sheet processing device, positions of the input unit and the payout unit in the vertical direction agree with each other, and positions of the input unit and the payout unit in a horizontal direction agree with each other.

11. The paper sheet processing device according to claim 1, wherein a position of the identification unit in the vertical direction agrees with a position of the temporary holding unit in the vertical direction, and the linear transport path extends in a horizontal direction.

12. The paper sheet processing device according to claim 1, wherein the paper sheet is a bill.

13. A paper sheet processing device comprising:
an input unit in which a paper sheet is input;
an identification unit that identifies the paper sheet that has been input in the input unit;
a temporary holding unit that temporarily holds the identified paper sheet;
a linear transport path that connects the identification unit and the temporary holding unit, extends in a straight line, and transports the paper sheet identified by the identification unit to the temporary holding unit; and
a first transportation path that is connected with the input unit, and transports the paper sheet that has been input in the input unit to the identification unit,
wherein the first transportation path is provided downward toward rear from front toward rear of the paper sheet processing device.

14. The paper sheet processing device according to claim 13, wherein a position of the identification unit in the vertical direction agrees with a position of the temporary holding unit in the vertical direction, and the linear transport path extends in a horizontal direction.

15. The paper sheet processing device according to claim 13, wherein the paper sheet is a bill.
